(19) United States
(12) Patent Application Publication
(10) Pub. No.: US 2024/0030762 A1
(43) Pub. Date: Jan. 25, 2024

(54) MOTOR

(71) Applicant: LG INNOTEK CO., LTD., Seoul (KR)

(72) Inventor: Jin Ho KIM, Seoul (KR)

(21) Appl. No.: 18/274,837

(22) PCT Filed: Mar. 8, 2022
(86) PCT No.: PCT/KR2022/003254

§ 371 Date: Jul. 28, 2023

(30) Foreign Application Priority Data
Mar. 9, 2021 (KR) 10-2021-0030848

(51) Int. Cl. H02K 1/278; H02K 7/00; H02K 11/21

(52) U.S. Cl. CPC H02K 1/278; H02K 7/003; H02K 11/21

(57) ABSTRACT

A motor comprises: a housing; a stator disposed inside the housing; a rotor disposed inside the stator; a shaft disposed in the center of the rotor; and a metal part disposed at one end of the shaft, wherein the shaft and the metal part are formed as one body.

### TECHNICAL FIELD

The present embodiment relates to a motor.

### BACKGROUND ART

The motor generates power while rotating by an interaction between a rotor having a plurality of magnets and an electromagnetic force generated by a coil wound around a stator.

Accordingly, the motor is provided with a shaft being formed to be rotatable, a rotor being coupled to the shaft, and a stator being fixed inside a housing, and the stator is installed with a gap along the circumference of the rotor.

In addition, a coil forming a rotating magnetic field is wound around the stator to induce electrical interaction with the rotor, thereby inducing rotation of the rotor. Therefore, when the rotor rotates, the shaft rotates.

The motor includes sensors for detecting the rotational positions of the rotor and shaft. The sensor may include a metal part being disposed on the rotor or shaft, and a sensing part for detecting the metal part. The metal part can rotate with the rotor or shaft.

The metal part according to the prior art is provided as a separate part, so there is a problem that an additional process for coupling with the rotor or shaft is consumed, and the manufacturing cost increases as the number of parts increases.

### DETAILED DESCRIPTION OF THE INVENTION

### Technical Subject

The present embodiment is to provide a motor capable of improving the structure, improving production efficiency, and lowering the manufacturing cost according to the reduction in the number of parts.

### Technical Solution

A motor according to the present embodiment comprises: a housing; a stator being disposed inside the housing; a rotor being disposed inside the stator; a shaft being disposed in the center of the rotor; and a metal part being disposed at one end of the shaft, wherein the shaft and the metal part are formed as one body.

It includes a sensor unit being disposed outside the rotor, and the sensor unit and the metal unit may be a motor position sensor (MPS) sensor.

The metal part may include pluralities of wing parts being disposed radially from one end of the shaft, and the pluralities of wing parts may be spaced apart from each other.

Each of the pluralities of wing parts may include: a first side surface; a second side surface facing the first side surface; and an outer circumferential surface connecting the first side surface and the second side surface.

The wing part may have a shape in which a circumferential distance between the first side surface and the second side surface increases as it travels toward the outside.

The curvature of the outer circumferential surface of the wing part may correspond to the curvature of the outer circumferential surface of the shaft.

A separation space is disposed between adjacent wing parts, and the circumferential length of the separation space may be shorter than the circumferential length of the wing part.

The metal part may be bent outward from one end of the rotating shaft, and the metal part and the rotating shaft may be perpendicular to each other.

The rotor includes a rotor core in which a magnet is disposed on an outer circumferential surface; and a cover being coupled to outer surfaces of the rotor core and the magnet.

A motor according to another embodiment comprises: a housing; a stator being disposed inside the housing; a rotor being disposed inside the stator; a shaft being disposed at the center of the rotor; and a sensor for detecting a position of the shaft or the rotor, wherein the sensor includes: a metal part being bent from one end of the shaft; and a sensor unit being disposed outside the rotor and detecting inductance of the metal part.

### Advantageous Effects

Through the present embodiment, there are advantages in that the number of parts and the manufacturing process are reduced by the integrated structure between the metal part and the shaft, thereby reducing manufacturing cost and enhancing production efficiency.

### BRIEF DESCRIPTION OF DRAWINGS

FIG. 1 is a conceptual diagram of a rotor assembly according to an embodiment of the present invention.

FIG. 2 is a perspective view of a rotor assembly according to an embodiment of the present invention.

FIG. 3 is an exploded perspective view of a shaft and a bearing coupling part according to an embodiment of the present invention.

FIG. 4 is an exploded perspective view of a motor according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

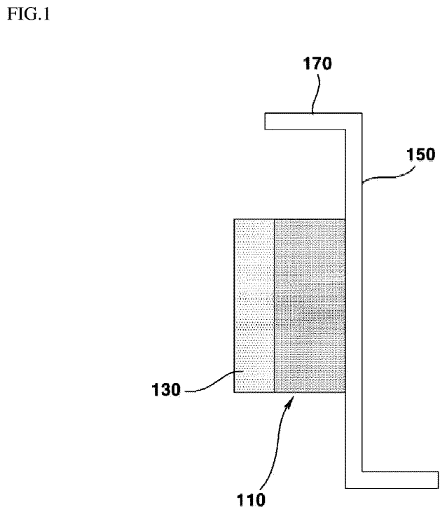

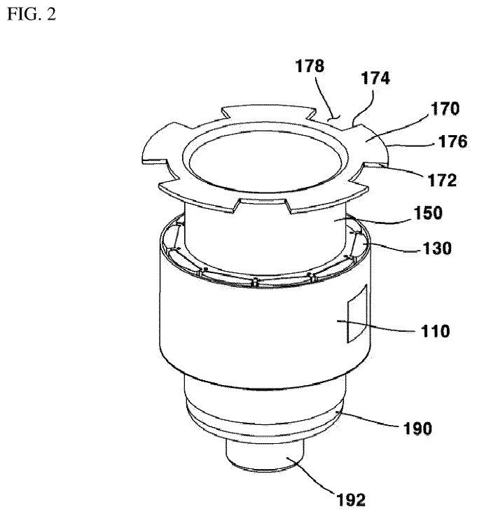

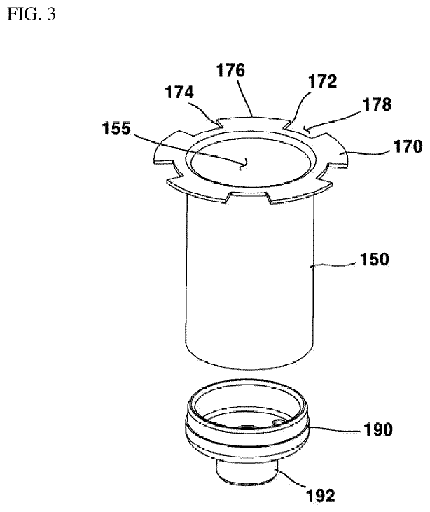

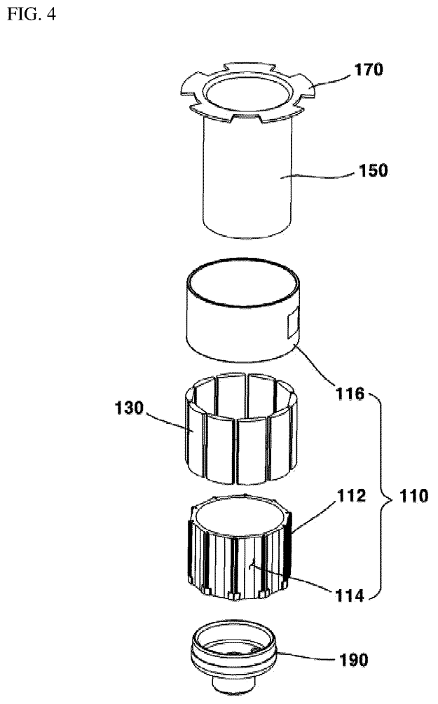

FIG. 1 is a conceptual diagram of a rotor assembly according to an embodiment of the present invention; FIG. 2 is a perspective view of a rotor assembly according to an embodiment of the present invention; FIG. 3 is an exploded perspective view of a shaft and a bearing coupling part according to an embodiment of the present invention; and FIG. 4 is an exploded perspective view of a motor according to an embodiment of the present invention.

Referring to FIGS. 1 to 4, a motor according to an embodiment of the present invention may include a housing (not shown), a stator (not shown) being disposed inside the housing, and a rotor assembly 100 being disposed inside the stator.

The housing forms an outer shape of the motor and may form a space in which the stator and the rotor assembly 100 are disposed. A printed circuit board (not shown) in which elements for driving the motor are disposed may be disposed inside the housing.

The stator is disposed inside the housing and may include a coil. A space may be formed in the center of the stator so that the rotor assembly 100 is disposed.

The rotor assembly 100 may be disposed inside the stator. The rotor assembly 100 may rotate inside the stator. To this end, the rotor assembly 100 may include a magnet 130. Accordingly, the rotor assembly 100 may rotate by electromagnetic interaction between the magnet 130 and the coil of the stator.

In detail, the rotor assembly 100 may comprise a rotor 110, a magnet 130, a shaft 150, a metal part 170, and a bearing coupling part 190.

The rotor 110 may include a rotor core 112 and a cover 116. The rotor 110 is disposed inside the stator and can rotate.

The rotor core 112 may form the body of the rotor 110. The rotor core 112 is formed to have a circular cross section, and an opening penetrating the lower surface from the upper surface may be formed in the center. The shaft 150 may be coupled to the opening.

The magnet 130 may be coupled to an outer circumferential surface of the rotor core 112. A magnet coupling part 114 may be disposed on an outer circumferential surface of the rotor core 112 so that the magnet 130 is coupled thereto. The magnet coupling part 114 may have a groove shape that is recessed more inward than other regions on the outer circumferential surface of the rotor core 112. The magnet coupling part 114 may be provided in plural and spaced apart from each other along the circumferential direction of the rotor core 112. Between the adjacent magnet coupling parts 114, partitions having a shape being protruded more outward than other regions may be disposed. At least a portion of the magnet 130 is accommodated in the magnet coupling part 114, and both side surfaces may come into contact with the inner surfaces of the partitions.

The magnet 130 may be disposed on an outer surface of the rotor core 112. The magnets 130 may be provided in plurality and disposed along the circumferential direction of the rotor core 112. The magnet 130 may be coupled to the rotor core 112 through a separate adhesive. The rotor 110 and the shaft 150 may rotate by electromagnetic interaction between the magnet 130 and the coil.

The cover 116 may be disposed outside the rotor core 112. The cover 116 may be coupled to cover the outer circumferential surface of the rotor core 112. The cover 116 may cover the outer surface of the magnet 130. That is, the magnet 130 may be interposed between the cover 116 and the rotor core 112. Upper and lower surfaces of the magnet 130 may be exposed to the outside. The cover 116 and the magnet 130 and the cover 116 and the rotor core 112 may be mutually coupled by an adhesive.

The shaft 150 may be disposed at the center of the rotor 110. The shaft 150 may be coupled by being press-fitted into the central opening of the rotor core 112. Accordingly, the shaft 150 may rotate together with the rotor 110. Upper and lower ends of the shaft 150 may be protruded upward and downward from the rotor 110, respectively.

The material of the shaft 150 may be non-magnetic.

A bearing coupling part 190 may be disposed at a lower end of the shaft 150. The bearing coupling part 190 may include a protruded portion 192 being protruded downward from other regions. The protruded portion 192 may have a smaller cross-sectional area than other regions. The protruded portion 192 is disposed inside a bearing (not shown), and rotation of the shaft 150 may be supported through the bearing. An outer surface of the protruded portion 192 may be in contact with an inner surface of the bearing inner ring. In addition, a portion of the upper end of the bearing coupling part 190 may be press-fitted into the shaft 150.

A motor according to the present embodiment may include a sensor. The sensor is for detecting the rotation of the rotor assembly 100 and may include a metal part 170 being disposed at one end of the shaft 150 and a sensor unit for detecting the metal part 170.

The rotor assembly 100 according to the present embodiment may include a metal part 170. The metal part 170 may be disposed at one end of the shaft 150. For example, the metal part 170 may be disposed at an upper end of the shaft 150. The metal part 170 may be a motor position sensor (MPS) sensor that detects a magnetic signal of the metal part 170 in a non-contact manner together with a sensor unit to be described later. The metal part 170 is formed of a non-magnetic material and may be integrally formed with the shaft 150. In other words, the metal part 170 may be formed with the shaft 150 as a single body. The shaft 150 and the metal part 170 may be made of a metal material.

The metal part 170 may have a shape being bent outward from an upper end of the shaft 150. The metal part 170 may be disposed perpendicular to the shaft 150.

The metal part 170 may include pluralities of wing parts. The plurality of wing parts may be disposed radially from an upper end of the shaft 150. The plurality of wing parts may be spaced apart from each other along the circumferential direction of the shaft 150. For example, the number of wing parts may be five. A separation space 178 separating the plurality of wing parts from each other may be disposed between the pluralities of wing parts. With respect to the circumferential direction, the length of the separation space 178 may be shorter than the length of the wing part.

Each of the pluralities of wing parts may include a first side surface 172, a second side surface 174, and an outer circumferential surface 176. The first side surface 172 and the second side surface 174 may be disposed to face each other. The outer circumferential surface 176 may connect the first side surface 172 and the second side surface 174.

The wing part may have a shape in which a distance in a circumferential direction between the first side surface 172 and the second side surface 174 increases as it travels toward the outside. The curvature of the outer circumferential surface 176 may correspond to the curvature of the outer circumferential surface of the shaft 150.

The sensor unit is disposed outside the rotor assembly 100 and can detect a change in position of the metal part 170. The sensor unit may detect the positions of the metal part 170 and the rotor assembly 100 by detecting inductance that changes according to the position change of the metal part 170. The sensor unit may include a coil or a chip being disposed on a printed circuit board (not shown) being disposed outside the rotor assembly 100. The sensor unit may be mounted on the printed circuit board.

According to the structure as described above, the number of parts and the manufacturing process are reduced by the integrated structure between the metal part and the shaft, thereby reducing manufacturing cost and enhancing production efficiency.

In the above description, it is described that all the components constituting the embodiments of the present invention are combined or operated in one, but the present invention is not necessarily limited to these embodiments. In other words, within the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas within the equivalent scope should be interpreted as being included in the scope of the present invention.

1. A motor comprising:
a housing;
a stator being disposed inside the housing;
a rotor being disposed inside the stator;
a sensor unit being disposed outside the rotor;
a shaft being disposed in the center of the rotor; and
a metal part being disposed at one end of the shaft,
wherein the sensor unit detects inductance of metal part that is changed according to rotation of the rotor, and
wherein the shaft and the metal part are formed as one body.

2. The motor according to claim 1,
wherein the sensor unit and the metal unit is a motor position sensor (MPS) sensor.

3. The motor according to claim 1,
wherein the metal part includes pluralities of wing parts being disposed radially from one end of the shaft, and
wherein the pluralities of wing parts are spaced apart from each other.

4. The motor according to claim 3,
wherein each of the pluralities of wing parts includes:
a first side surface;
a second side surface facing the first side surface; and
an outer circumferential surface connecting the first side surface and the second side surface.

5. The motor according to claim 4,
wherein the wing part has a shape in which a circumferential distance between the first side surface and the second side surface increases as it travels toward the outside.

6. The motor according to claim 4,
wherein the curvature of the outer circumferential surface of the wing part corresponds to the curvature of the outer circumferential surface of the shaft.

7. The motor according to claim 3,
wherein a separation space is disposed between adjacent wing parts, and
wherein the circumferential length of the separation space is shorter than the circumferential length of the wing part.

8. The motor according to claim 1,
wherein the metal part is bent outward from one end of the rotating shaft, and
wherein the metal part and the rotating shaft are perpendicular to each other.

9. The motor according to claim 1,
wherein the rotor includes:
a rotor core in which a magnet is disposed on an outer circumferential surface; and
a cover being coupled to outer surfaces of the rotor core and the magnet.

10. The motor according to claim 9, wherein a plurality of magnet coupling parts having a groove shape and a partition formed between the two magnet coupling parts are disposed on an outer surface of the rotor core.

11. The motor according to claim 10, wherein both side surfaces of the magnet are in contact with an inner surface of the partition.

12. The motor according to claim 1, wherein the shaft and the metal part are non-magnetic.

13. The motor according to claim 1, wherein a bearing coupling portion is disposed on an other end of the shaft, and
wherein the bearing coupling portion includes a protrusion disposed inside a bearing.

14. The motor according to claim 3, wherein the pluralities of wing parts are five.

15. The motor according to claim 9, wherein the cover, the magnet, and the rotor core are coupled to each other through an adhesive.

16. A motor comprising:
a housing;
a stator being disposed inside the housing;
a rotor being disposed inside the stator;
a shaft being disposed at the center of the rotor; and
a sensor for detecting a position of the shaft or the rotor,
wherein the sensor includes:
a metal part being bent from one end of the shaft; and
a sensor unit being disposed outside the rotor and detecting inductance of the metal part.

17. The motor according to claim 16, wherein the metal part includes pluralities of wing parts being disposed radially from one end of the shaft, and
wherein the pluralities of wing parts are spaced apart from each other.

18. The motor according to claim 17, wherein each of the pluralities of wing parts includes:
a first side surface;
a second side surface facing the first side surface; and
an outer circumferential surface connecting the first side surface and the second side surface.

19. The motor according to claim 18, wherein the wing part has a shape in which a circumferential distance between the first side surface and the second side surface increases as it travels toward the outside.

20. The motor according to claim 18, wherein the curvature of the outer circumferential surface of the wing part corresponds to the curvature of the outer circumferential surface of the shaft.
